(19) United States
(12) Patent Application Publication
(10) Pub. No.: US 2022/0348382 A1
(43) Pub. Date: Nov. 3, 2022

(54) Food packaging and Dispensing Method and Apparatus

(71) Applicants: Bethany L Szijarto, Brunswick, OH (US); Leo P Szijarto, Brunswick, OH (US)

(72) Inventors: Bethany L Szijarto, Brunswick, OH (US); Leo P Szijarto, Brunswick, OH (US)

(21) Appl. No.: 17/735,498

(22) Filed: May 3, 2022

Related U.S. Application Data
(60) Provisional application No. 63/258,396, filed on May 3, 2021.

(51) Int. Cl. B65D 25/04; A23L 19/00; A21D 2/36; A23L 2/02

(52) U.S. Cl. CPC B65D 25/04; A23L 19/09; A21D 2/36; A23L 2/02; A23V 2002/00

(57) ABSTRACT

A method supporting children choosing healthy foods in alternate form (desserts) to help them to increase their intake of fruits and vegetables by focusing on body functions (strength, vision, movement, memory, digestion, and all-in-one). The method uses special packaging approaches that associate healthy foods disguised as desserts, candy, chips, chewing gum, or frozen treats. This method would include body function labeled packaging in the form of pods, flaps, or sleeves that are engaging ways for quick lunch options for children. Children would have the freedom to choose a labeled pod, flap, or sleeve to help to improve their selected body function. Body function options could include superfoods in dessert form for strength, vision, movement, memory, digestion, and all-in-one.

### CROSS-REFERENCES TO RELATED APPLICATIONS

This application claims the benefit of U.S. Provisional Patent Application Ser. No. 63/258,396 filed on May 3, 2021, incorporated herein by reference.

### BACKGROUND

Many children do not eat enough fruits and vegetables, so other methods should be considered to improve nutrition. Unfortunately more children are growing into adulthood who are battling diabetes, heart disease, and cancer because of unhealthy eating.

Conventional approaches for helping children to eat fruits and vegetables is not always helpful. There are always going to be children who are picky eaters, so implementing new solutions would help more kids to acquire their needed daily nutrients is desirable. Although some approaches involving secretly inserting vegetables into products (e.g., spaghetti and macaroni meals in grocery stores), such methods do not allow for quick meal options for children outside of the home. Unfortunately, the conventional methods only help some children to eat the daily necessary vitamins and minerals for proper growth and development. Additionally, those quick meal options that help outside of the home have been heavily documented as being unhealthy.

A method is desired that will help children to eat more fruits and vegetables in order to obtain healthy vitamins and minerals. Many children refuse to eat superfoods, like kale and spinach, so disguising those foods allows children to increase their fruit and vegetable daily intake.

### SUMMARY

This application relates generally to a method supporting children choosing superfoods in alternate form (desserts) to help them to increase their intake of fruits and vegetables by focusing on body functions (strength, vision, movement, memory, digestion, and all-in-one).

More specifically, with this method, superfoods are disguised as desserts, candy, chips, chewing gum, or frozen treats. This method would include body function labeled packaging in the form of pods, flaps, or sleeves that are engaging ways for quick lunch options for children, as opposed to the current “unhealthy” options available at the grocery store. Children would have the freedom to choose a labeled pod, flap, or sleeve to help to improve their selected body function. Body function options would include superfoods in dessert form for strength, vision, movement, memory, digestion, and all-in-one.

Further, each superfood dessert pod, sleeve, or flap will be labeled individually with the specific body function that the superfood promotes in a healthy diet.

Provided are a plurality of example embodiments, including, but not limited to, a method of dispensing healthy food to a child, comprising the steps of: providing a plurality of separate storage compartments organized into a single organizing apparatus, wherein each one of said plurality of storage compartments is configured to be separately sealed and individually opened; providing a plurality of different healthy foods, each one of said different healthy foods configured for providing a different particular benefit to the child; packaging each one of said plurality of different healthy foods into a separate one of said plurality of storage compartments, wherein each one of said storage compartments has a different one of said plurality of different healthy foods provided therein; and labeling each one of said storage compartments with the particular benefit provided by the healthy food provided therein.

Also provided is a device including the storage compartments of the method organized into the single organizing apparatus with the respective healthy foods provided therein.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a first example showing a front aerial view of example individual pods enclosed by a box container;

FIG. 2 is the first example showing a front elevation view of the pod in closed position;

FIG. 3 is the first example showing a side elevation view of the pod in open position;

FIG. 4 is a second example showing a front elevation view of individual sleeves enclosed by a box container in an open position;

FIG. 5 is the second example showing a front elevation view of the sleeve in closed position;

FIG. 6 is a third example showing a front aerial view of individual compartments with flaps enclosed by a box container;

FIG. 7 is the third example showing a front elevation view of individual compartment with flap in closed position; and

FIG. 8 is the third example showing a side elevation view of individual compartment with flap in open position.

### DETAILED DESCRIPTION OF THE EXAMPLE EMBODIMENTS

Provided are a plurality of embodiments of the invention, including, but not limited to, individually labeled body function packaging: pods, sleeves, or flaps that can help to facilitate children increasing their daily intake of fruits and vegetables by disguising superfoods in alternate forms.

Examples of healthy foods or superfoods that may be packaged in the alternate format and/or used as ingredients in the food are listed, but not limited to the following: spinach, kale, eggs, oranges, chickpeas, coconut flour, cinnamon, strawberries, raspberries, carrots, honey, oats, banana, peanut butter, dark chocolate, apples, dates, cauliflower, and Greek yogurt.

Examples of superfood dessert recipes by body function that can be utilized include:

Donut (for healthy bone & muscle strength)—1 TBL dehydrated kale in powder form, 1 TBL dehydrated spinach in powder form, 4 TBL crushed chickpeas, 2 oranges squeeze juice, 4 TBL coconut flour, ½ TSP vanilla, 1 egg white, cinnamon, 1 crushed banana. Blend ingredients together and bake at 350 degrees for 15-20 minutes. Melt ½ cup of dark chocolate morsels and drizzle over baked and cooled donuts.

Muffin (for healthy vision)—6 strawberries, 6 raspberries, 1 TBL dehydrated kale in powder form, 1 TBL dehydrated spinach in powder form, 5 baby carrots, 3 TSP of sweet potato baked, ½ TSP baking powder, 3 TSP coconut flour, 1 TSP honey. Blend ingredients together and bake in muffin pan a 350 degrees for 25 minutes.

Cookie (for healthy muscle movement)—½ cup of oats, 1 banana, 1 TBL of dehydrated kale powder, 1 TBL of dehydrated spinach powder, 2 TBL of peanut butter, ½ TSP baking powder, ½ TSP of baking soda, sprinkle cinnamon. Blend ingredients together and bake at 350 degrees for 8 minutes 30 seconds.

Protein Ball (for healthy memory)—½ chopped apple, 2 chopped dates, ½ cup smashed chickpeas, ½ cup cooked cauliflower rice, 1 TSP dark chocolate. Blend ingredients in food processor and roll into protein balls. Serve cold.

Smoothie or Fruit Leather (for healthy digestion or all-in-one)—1 chopped apple, 1 TSP dehydrated kale powder, 1 TSP dehydrated spinach powder, 2 TBL Greek vanilla yogurt, 6 strawberries, 6 raspberries (for all-in-one also add the following: 1 TSP crushed chickpea, 1 TSP shredded carrot, ⅛ cup crushed banana, ⅛ cup riced cauliflower). Blend all ingredients in a blender. Serve as smoothie or spread 2 TBL of mixture on a baking sheet to dehydrate for 12 hours. Serve smoothie as a drink or as fruit (vegetable) leather.

Additionally, there is an assortment of dessert type examples listed that may be constructed and packaged in the alternate formats so as to provide a large selection for quick lunches or healthy dessert options such as: cakes, cake pops, chips, biscuits, custards, gelatin, pies, puddings, sweet soups, tarts, fruit salads, mousse, donuts, bars, brownies, muffins, protein balls, cookies, candy, fruit leather, mints, chewing gum, gummies, sucker candies, veggie straws, cupcakes, pastries, scones, pancakes, waffles, candy bars, fruit (and vegetable) leather, popsicles, coolant drinks, juices, apple crisps, cobblers, gelato, cheesecake, smoothies, and frozen treats like ice cream sandwiches, frozen yogurt, frozen breakfasts, popsicles, ice cream bars, ice cream cones, ice cream, and push ups.

Each packaging format of superfood for the specific dessert is highlighted below to help increase the intake of fruits and vegetables by body function (strength, vision, movement, memory, digestion, and all-in-one).

Pod packaging includes a number of individual pods (e.g., 6 pods) that are attached to each other that fit into an organizing box. Each individual pod can be opened and closed to retrieve the superfood dessert. The pods are made of plastic, food-grade cardboard, or other material that can store food and allow to close with a plastic/cardboard clasp.

Sleeve packaging includes a number of individual sleeves (i.e., 12 or 24 sleeves) that are individually stored in a box together. Each individual sleeve can be opened and closed with a resealable opening or the plastic may be torn or cut to open the sleeve. The sleeves can be made of plastic or material that can store food.

Flap packaging includes a number of individual flap containers (e.g., 6 flap containers) that are individually stored in a organizing box together. Each individual flap can be opened and closed where the flap sticks to the top of the container. The flaps are made of plastic or other material that can be opened or reopened with a sticky adhesive.

Various superfoods in alternate form (desserts) that are encapsulated within the body function labeled packaging is discussed, as are methods utilizing these superfood options for implementing the invention. For example, a superfood dessert packaging to help children intake more fruits and vegetables helps kids to choose how to improve their body functions. Children may choose to eat a healthy diet by increasing their fruits and vegetables by choosing a body function like, strength, vision, movement, memory, digestion, or all-in-one by selecting a pod, flap, or sleeve packaging. Also provided are methods of implementing fruits and vegetables, including healthy foods and superfoods, such as kale and spinach in alternative form (desserts).

A superfood dessert packaging that focuses on improving bone and muscle strength, includes a healthy form of baked goods, non-baked items, or frozen treats. Also provided, but not limited to, are methods of implementing kale, spinach, coconut flour, chickpeas, oranges, eggs, banana, and cinnamon.

A superfood dessert packaging that focuses on improving vision, includes a healthy form of baked goods, non-baked items, or frozen treats. Also provided, but not limited to, are methods of implementing kale, spinach, strawberries, raspberries, carrots, honey, eggs, coconut flour, and dark chocolate chips.

A superfood dessert format packaging that focuses on improving muscle movement, includes a healthy form of baked goods, non-baked items, or frozen treats. Also provided, but not limited to, are methods of implementing oats, bananas, kale, spinach, dark chocolate chips, coconut flour, and peanut butter.

A superfood dessert format packaging that focuses on improving the brain (memory), includes a healthy form of baked goods, non-baked items, or frozen treats. Also provided, but not limited to, are methods of implementing apples, kale, spinach, dates, chickpeas, cauliflower, and dark chocolate chips.

A superfood dessert format packaging that focuses on improving digestion, includes a healthy form of baked goods, non-baked items, or frozen treats. Also provided, but not limited to, are methods of implementing apples, kale, spinach, strawberries, raspberries, and Greek yogurt.

The superfood dessert formats, such as one of the superfood dessert format options disclosed herein, would typically be packaged together with other superfood dessert formats for a healthy quick lunch option within the same meal packaging. The portion of the superfood dessert formats would be limited to one serving per superfood dessert format. For example, there would be at least one superfood dessert for each of a plurality of body functions (e.g., strength, vision, movement, brain, digestion, and all-in-one) per overall superfood dessert packaging.

The process includes parents who purchase a superfood meal to give to their child for a healthy quick lunch or snack, so as to increase the child's intake of fruits and vegetables for the day. The picky eater is more likely to choose fruits and vegetables when disguised as healthy but tasty desserts, so this method has potential to help to reduce future adverse health issues for children. This method assists with increasing the intake of fruits and vegetables due to the superfood dessert packaging because children have an interest in eating desserts. The children do not realize that each food is a healthy option packed full of nutrients. This method helps picky eaters to make healthy choices. The method may be packaged for refrigerator, freezer, or shelf options depending on the type of superfood dessert format.

Alternative ways to use this method are for frozen yogurt, ice cream, sucker candies, fudge, chips, veggie straws, and frozen breakfast including the fruits and vegetables listed previously.

In use, the superfood dessert formats disclosed herein are packaging of the fruits and vegetables in alternate form, such as a tasty dessert, that help to promote a healthy diet by increasing the intake of fruits and vegetables by body functions of such invention. Such a superfood dessert packaging format is included with other dessert options or is offered individually within a box, bag, wrapper, drink box, or squirt pouch.

The figures, described below, show examples of different food packaging approaches that can be used to package the superfoods.

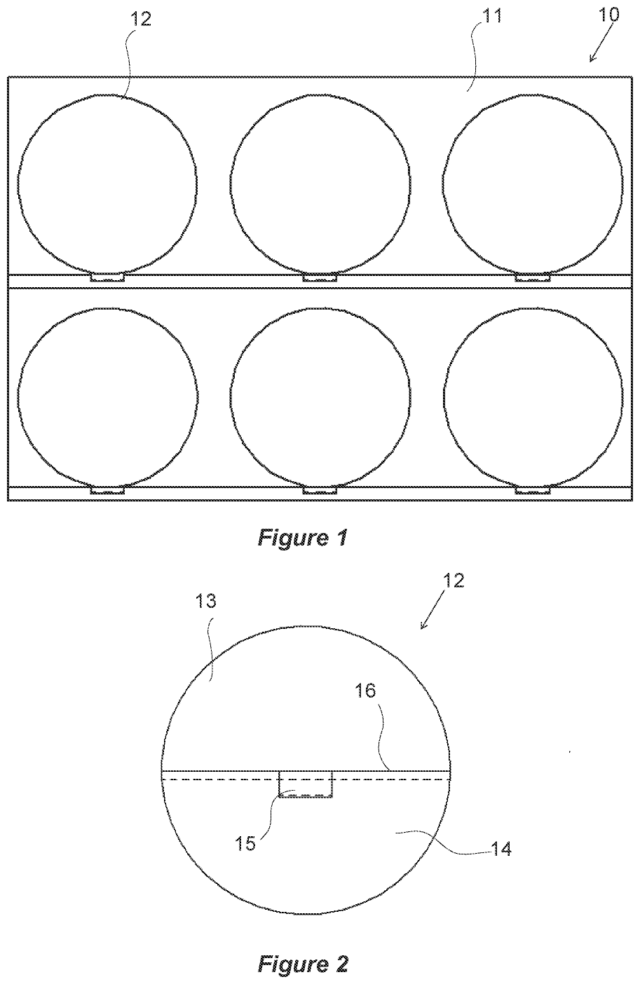

A container using individual pod packaging 10 is shown in FIG. 1. The pods packaging includes several contiguous pods 12 in rows and columns that fit into an overall compartment (i.e., box) 11. The pods packaging allows children to choose a body function from the individual pods to increase their fruits and vegetables by opening a pod to consume the superfood dessert provided in that pod.

The individual pod packaging 10 stores different superfood desserts labeled by body function in each of the pods 12. The pod packaging 10 allows for children to choose a pod corresponding to a particular body function, thereby increasing their fruits and vegetables, by opening pods and consuming the superfood dessert contained therein, which may incorporate the recipes that are described hereinabove, or other recipes.

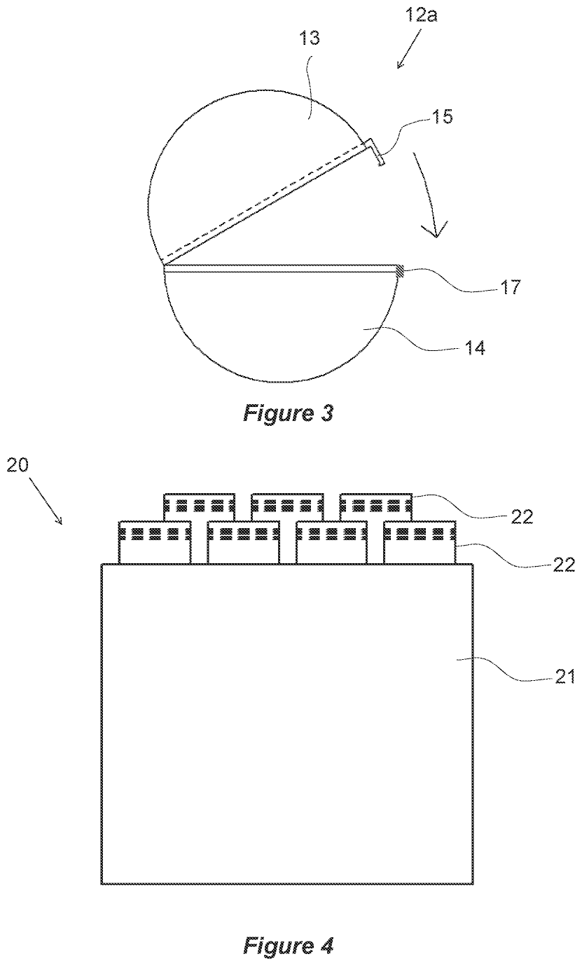

An overview of the open individual pod as provided as shown in FIGS. 2 and 3. The individual pod views show how the closed pod 12 of FIG. 2 would be opened as shown by the open pod 12a in FIG. 3, for children to remove the superfood dessert. The pods 12 have a top portion 13, a bottom portion 14, a latch 15 on the top portion 13 that latches the lip 17 provided on the bottom portion, sealing the food into the pod at seal 16. The latch 15 can be used to open and close the pod 12 for individual selection. This pod can be packed with food specific to either strength, vision, movement, memory, digestion, all-in-one, or other body functions as desired.

The individual pods 12 can be labeled with the body functions corresponding to the foods provided therein and enclosed within the box 11 as shown in FIG. 1. The pods body function labeling can be provided on top of the contiguous pods in rows and columns that fit into an overall compartment (i.e., box). The labeled pods allow children to choose which body function they want to improve to help increase their fruits and vegetables.

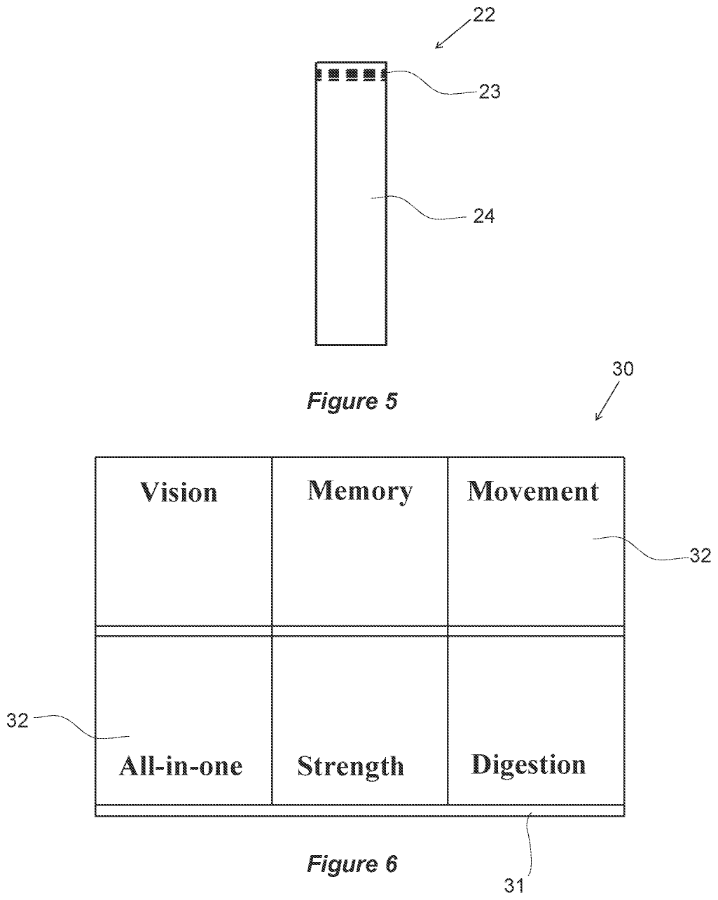

An overview of a second packaging option is shown in FIGS. 4-5. In FIG. 4, sleeve packaging 20 is shown. The sleeve packaging includes several storage sleeves 22 that fit into an overall compartment (i.e., box or bag) 21. The sleeves packaging 20 allows for children to choose a body function from an individual sleeve to increase their fruits and vegetables by opening the sleeve and consuming the superfood dessert. FIG. 5 shows a sleeve individual view 22. The sleeve individual view provides a resealable top opening 23 of the sleeve, which could be a screw cap, for example, sealing the sleeve container 24. The sleeve 20 allows children to remove the superfood dessert from storage. The individual sleeve will be specific to either strength, vision, movement, memory, digestion, all-in-one, or other body function.

The individual sleeves 22 in the sleeve packaging can be labeled with body functions and enclosed within the box 21 as shown in FIG.4. The sleeves body function labeling can be provided on top of the sleeves packaging that fit into the overall box 21. The labeled sleeves allow children to choose which body function they want to improve to help increase their fruits and vegetables.

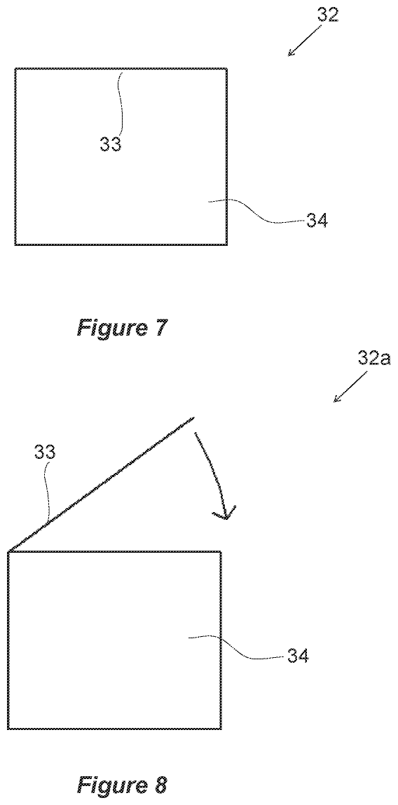

FIGS. 6-7 show a third packaging option.

FIG. 6 shows example flap compartment packaging 30. The flaps compartments packaging 30 includes several contiguous compartments 32 in rows and columns that fit into an overall box 31. This packaging allows children to choose a body function to increase their fruits and vegetables by lifting a flap to consume the superfood dessert.

Body function labeling is shown printed on top of the contiguous compartments 32 in rows and columns that fit into an overall box 31. The labeled flaps allow children to choose which body function they want to improve to help increase their fruits and vegetables.

A closed flap individual compartment 32 is shown in FIG. 7 with flap 33 in a closed position covering the storage compartment 34, and in FIG. 8 with flap 33 in an open position providing access to the storage compartment 34. The flap individual view includes a plurality of flap compartments 32 (six are shown) that fit into an overall box 31. Note that the compartments 32 could be made integral with the box 31, or as removable compartments.

The flap compartments individual view shows how the flap would be closed and sticks to an edge for children to open and remove the superfood dessert. This flap will be specific to either strength, vision, movement, memory, digestion, all-in-one, or other body function.

The flap individual view includes compartments 32 that fit into the overall box 31. The flap would be opened by pulling the flap from the adhesive edge for children to open and remove the superfood dessert. This flap will be specific to either strength, vision, movement, memory, digestion, all-in-one, or other body function.

These different types of packaging are used as they all fit into an organizing box that would resemble a lunch kit or portable type convenience meal. The sleeves can accommodate products that are fluid or that can flow, where they fit into a box like a squeezable yogurt that come with many sleeves. Commercial products such as Lunchable® style and Gogurt® boxes can be accommodated. Children can engage with the boxes by individual selection by choosing their superpower or superfood dessert that helps improve a body function.

Although the examples show embodiments having six different storage compartments each storing a different type of food, any number of storage compartments could be used, from 2, 3, 4, 5, 6, 7, 8, or more. This allows providing for a variety of foods each targeting a different benefit for the child.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of dispensing healthy food to a child, comprising the steps of:
providing a plurality of separate storage compartments organized into an organizer, wherein each one of said plurality of storage compartments is configured to be separately sealed and individually opened;
providing a plurality of different healthy foods, each one of said different healthy foods configured for providing a different particular benefit to the child;
packaging each one of said plurality of different healthy foods into a separate one of said plurality of storage compartments, wherein each one of said storage compartments has a different one of said plurality of different healthy foods provided therein; and
labeling each one of said storage compartments with the particular benefit provided by the healthy food provided therein.

2. The method of claim 1, wherein each one of said separate storage compartments is configured to be removable from said organizing apparatus.

3. The method of claim 1, wherein each one of said plurality of different healthy foods includes one or more vegetables.

4. The method of claim 3, wherein each one of said plurality of different healthy foods includes one or more fruits.

5. The method of claim 1, wherein each one of said plurality of different healthy foods includes one or more fruits.

6. The method of claim 1, wherein each one of said plurality of different healthy foods is configured to taste like a different dessert.

7. The method of claim 1, wherein said plurality of separate storage compartments includes at least four storage compartments and wherein said plurality of different healthy foods includes at least four different foods.

8. The method of claim 1, wherein said plurality of different healthy foods includes at least four different desserts.

9. The method of claim 1, wherein said plurality of different healthy foods include healthy versions of a donut, muffin, cookie, protein ball, smoothie, and/or fruit leather.

10. The method of claim 1, wherein said plurality of different healthy foods include a plurality of healthy versions of a donut, muffin, cookie, protein ball, smoothie, and/or fruit leather.

11. The method of claim 1, wherein each one of said plurality of separate storage compartments is configured with a lid that can be opened and sealed closed.

12. A system for performing the method of claim 1 comprising the plurality of separate storage compartments organized into a single organizing apparatus, wherein each one of said storage compartments has the different one of said plurality of different healthy foods provided therein.

13. A method of dispensing healthy food to a child, comprising the steps of:
providing a plurality of separate storage compartments organized into an organizer, wherein each one of said plurality of storage compartments is configured to be separately sealed and individually opened using a closable lid;
providing a plurality of different healthy desserts, each one of said different healthy desserts including a vegetable and/or a fruit configured for providing a different particular benefit to the child;
packaging each one of said plurality of different healthy foods into a separate one of said plurality of storage compartments, wherein each one of said storage compartments has a different one of said plurality of different healthy foods provided therein; and
labeling each one of said storage compartments with the particular benefit provided by the healthy food provided therein, wherein
each one of said separate storage compartments is configured to be removable from said organizing apparatus.

14. The method of claim 13, wherein said plurality of different healthy foods include healthy versions of a donut, muffin, cookie, protein ball, smoothie, and/or fruit leather.

15. The method of claim 13, wherein said plurality of different healthy foods include a plurality of healthy versions of a donut, muffin, cookie, protein ball, smoothie, and/or fruit leather.

16. The method of claim 13, wherein said plurality of separate storage compartments includes at least four storage compartments and wherein said plurality of different healthy foods includes at least four different foods.

17. The method of claim 13, wherein said plurality of different healthy foods includes at least four different desserts.

18. A system for performing the method of claim 13 comprising the plurality of separate storage compartments organized into a single organizing apparatus, wherein each one of said storage compartments has the different one of said plurality of different healthy foods provided therein.

19. A system to dispense healthy food to a child, comprising:
a plurality of four or more separate storage compartments organized into an organizer, wherein each one of said plurality of storage compartments is configured to be separately sealed and individually opened using a closable lid;
a plurality of four or more different healthy desserts, each one of said different healthy desserts including a vegetable and/or a fruit configured for providing a different particular benefit to the child;
wherein each one of said plurality of different healthy foods is provided into a separate one of said plurality of storage compartments, such that each one of said storage compartments has a different one of said plurality of different healthy foods provided therein; and
wherein each one of said storage compartments is labeled with the particular benefit provided by the healthy food provided therein; and
wherein each one of said separate storage compartments is configured to be removable from said organizing apparatus.

20. The method of claim 19, wherein said plurality of different healthy foods include a plurality of healthy versions of a donut, muffin, cookie, protein ball, smoothie, and/or fruit leather.
